(19) United States
(12) Patent Application Publication
(10) Pub. No.: US 2010/0171956 A1
(43) Pub. Date: Jul. 8, 2010

(54) Alignment Free Single-Ended Optical Probe and Methods for Spectroscopic Measurements in a Gas Turbine Engine

(75) Inventors: Andrew D. Sappey, Lakewood, CO (US); Henrik Hofvander, Boulder, CO (US)

Correspondence Address: SWANSON & BRATSCHUN, L.L.C., 8210 SOUTHPARK TERRACE, LITTLETON, CO, 80120, US

(73) Assignee: ZOLO TECHNOLOGIES, INC., Boulder, CO (US)

(21) Appl. No.: 12/359,900

(22) Filed: Jan. 26, 2009

Related U.S. Application Data
(60) Provisional application No. 61/143,109, filed on Jan. 7, 2009.

(51) Int. Cl. G01N 21/00; G01M 15/14

(52) U.S. Cl. 356/432; 73/112.01

(57) ABSTRACT

A method of measuring the combustion property in a measurement volume within a casing defined in part by a casing wall. The method includes providing a port in the chamber wall. Also provided is a fiber assembly comprising a single mode transmit core surrounded by a multimode receive core means. The fiber assembly is operatively coupled to the port to provide optical communication between the fiber assembly and measurement volume. A detection beam capable of detecting a select combustion property is transmitted from the single mode fiber and reflected off a reflection surface within the chamber, the reflection surface being configured to reflect and optically couple at least a portion of the detection beam to the multimode receive core means. The detection beam optically coupled to the multimode receive core means is then measured.

### RELATED APPLICATIONS

This application claims priority from U.S. Provisional Patent Application Ser. No. 61/143,109, filed Jan. 7, 2009, entitled “Alignment Free Single-Ended Optical Probe and Methods for Spectroscopic Measurements in a Gas Turbine Engine,” which is hereby incorporated by reference.

### TECHNICAL FIELD

The present disclosure is directed toward an alignment free single-ended optical probe and method for monitoring and control of a combustion process, and more particularly toward a method and apparatus for spectroscopic measurements of combustion properties of a gas turbine engine.

### BACKGROUND OF THE INVENTION

Laser-based spectroscopic instruments have been implemented in a variety of environments to extract measurement data. Laser-based measurement apparatus can be implemented in situ and offer the further advantage of high speed feedback suitable for dynamic process control. One technique for measuring combustion species such as gas composition, gas concentration, temperature and other combustion parameters (collectively, “combustion properties”) utilizes Tunable Diode Laser Absorption Spectroscopy (TDLAS). TDLAS is typically implemented with diode lasers operating in the near-infrared and mid-infrared spectral regions. Suitable lasers have been extensively developed for use in the telecommunications industry and are, therefore, readily available for TDLAS. Various techniques for TDLAS which are more or less suitable for sensing control of combustion processes have been developed. Commonly known techniques are wavelength modulation spectroscopy and direct absorption spectroscopy. Each of these techniques is based upon a predetermined relationship between the quantity and nature of laser light received by a detector after the light has been transmitted through a combustion zone (or combustion chamber) and absorbed in specific spectral bands which are characteristic of the combustion species present in the combustion zone. The absorption spectrum received by the detector is used to determine the combustion properties, including the quantity of the combustion species under analysis and associated combustion parameters such as temperature.

One particularly useful implementation of TDLAS utilizes wavelength-multiplexed diode laser measurements in order to monitor multiple combustion species and combustion parameters. One such system is described in PCT/US2004/010048 (International Publication No. WO 2004/090496) entitled “Method and Apparatus for the Monitoring and Control of Combustion” (“WO '496”), the content of which is incorporated in its entirety herein.

Determining combustion properties can be used to improve combustion efficiency in, for example, gas turbine engines, while simultaneously reducing the harmful emissions such as nitrogen oxides. Monitoring combustion properties within gas turbine engines also has the potential to improve turbine blade lifetime and all other engine components aft of the combustion zone as well as providing a useful diagnostic to identify malfunctioning engines.

While monitoring combustion properties in gas turbine engines would appear to have many potential benefits, making the measurements has proven extremely difficult. The difficulty stems from two major sources. First, the high-pressure and temperature in the immediate vicinity of the combustion zone (30-40 bar, 2200 K) creates an environment in which normal spectral features are highly distorted, leading to difficulty in interpreting data even if it can be obtained. Second, making such measurements in an operating engine requires optical access; that is, a penetration or penetrations in the engine casing through which one can direct a laser beam over a line of sight. This is very difficult to arrange in an operating gas turbine engines due to the harsh nature of the engine environment, the limited space available for monitoring components and the need to minimize impact on critical components.

To illustrate the difficulty of providing line of sight optical access in and around the combustion zone of a gas turbine engine, FIG. 1 is a schematic view of a gas turbine engine 10 including a combustion zone 12. The combustion zone 12 is defined between a cylindrical outer casing 14 and a cylindrical inner casing 16. A turbine shaft 18 resides within the inner casing 16. The confined area in the vicinity of the combustion zone complicates effective access.

FIG. 2 is a schematic cross-section of the combustion zone 12 taken along lines A-A of FIG. 1. FIG. 2 shows the cylindrical outer casing 14, the cylindrical inner casing 16, the turbine shaft 18 and a number of combustor fuel cups 20 between the inner and outer casings. One possibility for providing line of sight access to the combustion zone is to provide a transmitting optic 22 associated with the borescope port 24 on the outer casing and a receiving optic 26 associated with a port in the inner casing 16. However, the turbine shaft that is housed in the inner casing 16 prevents any optics from being placed inside the inner casing 16.

A second possibility is illustrated in FIG. 3, with like reference numbers associated with like elements. Here a line of sight is provided by passing the laser from one borescope inspection port 24A to a second borescope inspection port 24B. In such an embodiment, the line of sight skirts the central inner casing 16 essentially forming a cord 28 through the annular combustion space. While potentially feasible, such a design is problematic because of the high-pressure, high-temperature environment and the difficulty of steering the beam at the severe angle required by the engine geometry.

Solutions to certain of the problems set forth above are described in International Patent Publication No. WO 2007/087081 entitled “Method and Apparatus for Spectroscopic Measurements in the Combustion Zone of the Gas Turbine Engine” (the '081 application). The '081 application is incorporated herein by reference in its entirety. As disclosed therein, spectroscopic measurements in the combustion zone of a gas turbine engine may be made by transmitting a TDLAS probe beam from a transmit optic coupled to a bore in the outer casing of a gas turbine engine. The beam may be reflected off a portion of the engine inner casing 16 which is substantially opposite the port. Thus, the primary method described in the '081 application requires that the beam be projected along a line which is substantially normal to the inner casing 16. This configuration is illustrated in FIG. 4 herein.

In certain implementations, however, it may be difficult or impossible to transmit a probe beam along a line which is normal to the inner casing 16 surface. In addition, the inner casing may in certain instances prove to be an unsuitable reflective surface. Some of these problems have been solved by a single-ended probe and methods for spectroscopic measurement in the combustion zone of a gas turbine engine described in International Patent Application No. PCT/US08/79935, filed Oct. 15, 2008, entitled “In Situ Optical Probe and Methods,” the contents of which are incorporated in their entirety herein. While this single-ended probe requires minimal access and does not require direct line of sight, alignment of the transmit optic relative to the receive optic in this single-ended probe is quite sensitive and as the probe/engine heat up, the optical alignment may change. Thus, a method of measuring combustion properties without alignment and an apparatus for measuring combustion properties without alignment are highly desirable.

### SUMMARY OF THE INVENTION

A first aspect is a method of measuring the combustion property in a measurement volume within a casing defined in part by a casing wall. The method includes providing a port in the chamber wall. Also provided is a fiber assembly comprising a single mode transmit core surrounded by a multimode receive core means. The fiber assembly is operatively coupled to the port to provide optical communication between the fiber assembly and measurement volume. A detection beam capable of detecting a select combustion property is transmitted from the single mode fiber and reflected off a reflection surface within the chamber, the reflection surface being configured to reflect and optically couple at least a portion of the detection beam to the multimode receive core means. The detection beam optically coupled to the multimode receive core means is then measured.

The multimode receive core means may comprise a plurality of multimode fibers abuttingly surrounding a single mode fiber including the single mode core. Alternatively, the multimode receive core means may comprise an integral multimode core encasing the single mode core. The method may further comprise transmitting a wavelength multiplexed beam from the single mode fiber, demultiplexing the at least a portion of the wavelength multiplexed beam and measuring each of the demultiplexed wavelengths of light.

Another aspect is an apparatus for measuring a combustion property using a measurement volume within a casing defined in part by a casing wall. The apparatus comprises a fiber assembly comprising a single mode transmit core surrounded by multimode receive core means and means optically coupling the fiber assembly to a port in the chamber wall. A reflection surface is provided within the chamber and is configured to reflect at least a portion of a detection beam to the multimode receive core means. A detector is optically coupled to the multimode receive core means for measuring the at least a portion of the detection beam.

The multimode receive core means may comprise a plurality of multimode fibers abuttingly surrounding a fiber containing the single mode core. Alternatively, the multimode receive core means comprises an integral multimode core encasing the single mode core. The apparatus may further comprise a demultiplexer coupled to the multimode receive core means and a plurality of detectors optically coupled to the demultiplexer for measuring each demultiplexed wavelength.

### BRIEF DESCRIPTION OF THE DRAWINGS

FIG. 1 is a partial sectional view taken along a lengthwise axis of a schematic representation of a gas turbine engine;

FIG. 2 is a schematic cross-sectional view of the combustion zone of the gas turbine engine of FIG. 1 taken along lines A-A of FIG. 1 illustrating one potential optical coupling of a transmitting/receiving optic pair;

FIG. 3 is similar to FIG. 2 only illustrating a second potential coupling of a transmitting/receiving optic pair;

FIG. 4 is similar to FIG. 2 only illustrating coupling of a transmitting/receiving optic pair configured in accordance with the method described in WO 2007/087081;

FIG. 5 is a schematic diagram of an embodiment where the spectroscopy probe beam is transmitted along a line which is not substantially normal to the inner casing of a gas turbine engine;

FIG. 6 is a schematic diagram of an embodiment where the spectroscopy probe beam is reflected off a separate structure;

FIG. 7 is a schematic cross section of a fiber bundle of a first embodiment of an alignment free single-ended optical probe;

FIG. 8 is a schematic representation of the first embodiment of an alignment free single-ended optical probe optically coupled to a measurement volume;

FIG. 9 is a schematic representation of coupling the multimode receive fibers to demultiplexers and detectors;

FIG. 10 is a schematic cross-sectional view of a dual core fiber utilizing a second embodiment of an alignment free single-ended optical probe;

FIG. 11 depicts the second embodiment of an alignment free single-ended optical probe optically coupled to a measurement volume;

FIG. 12 is a schematic representation of coupling of a dual core probe to a detector;

FIG. 13 illustrates an alternate embodiment of coupling the dual core probe to a detector;

FIG. 14 is a schematic representation of an embodiment of an apparatus for measuring combustion parameters within a gas turbine engine in accordance with the present disclosure using a single wavelength beam input; and

FIG. 15 is a schematic representation of an embodiment of an apparatus for measuring combustion parameters within a gas turbine engine in accordance with the present disclosure using a multiplexed beam input.

### DETAILED DESCRIPTION OF THE EMBODIMENTS

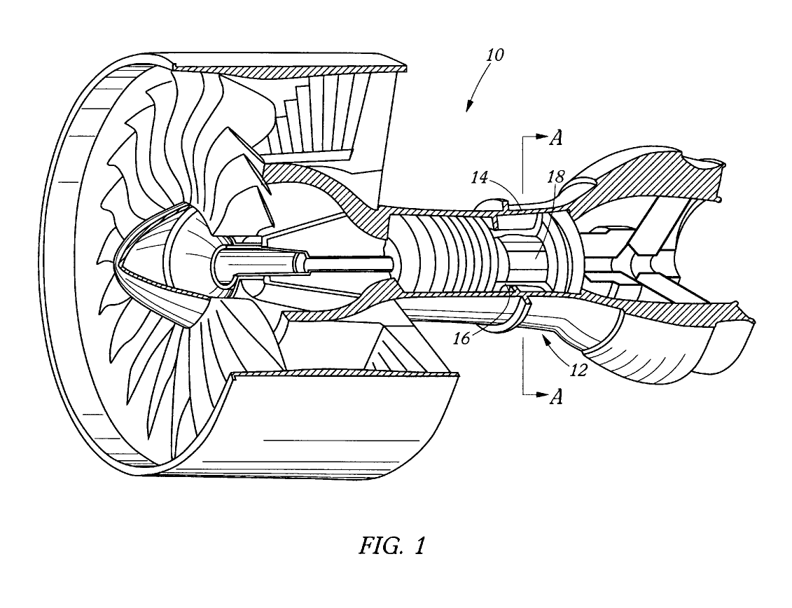

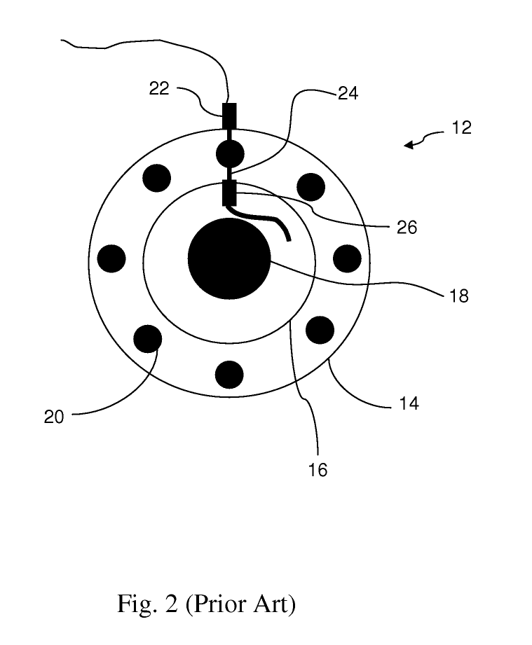

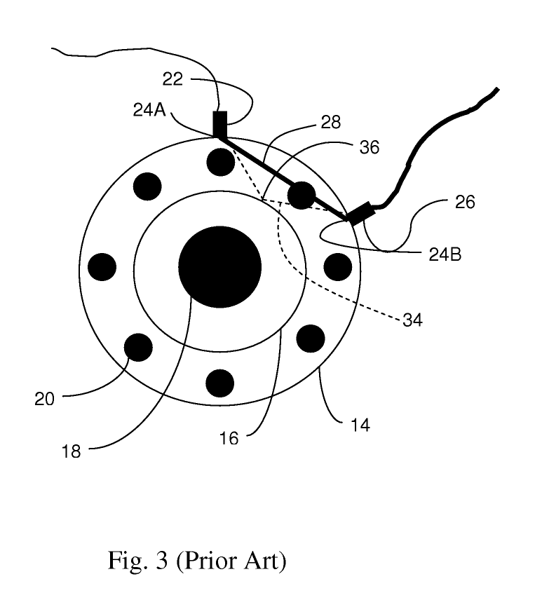

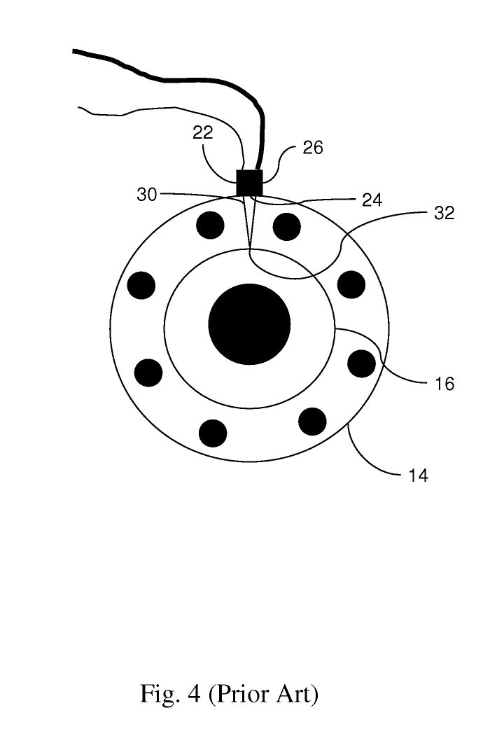

FIG. 1, which is described briefly above depicts in schematic form a partial sectional view taken along an axis of a gas turbine engine 10 illustrating the combustion chamber 12. FIG. 4 is a cross-section view taken along lines A-A of FIG. 1 illustrating in schematic form the operative association of a transmitting optic 22 and a receiving optic 26 pair in accordance with the disclosure of the '081 application referenced and incorporated hereinabove. In the embodiment illustrated in FIG. 4, the transmitting/receiving optics pair 22, 26 are optically coupled to a port 24 in an outer casing 14 and physically secured to the outer casing. The port 24 may be a borescope port which is a penetration in the outer casing available near the combustion zone on many modern gas turbine engines. The borescope ports are intended to allow observations of the turbine blade during servicing, but are further intended to be accessible only when the engine is not running. Thus, these ports typically are plugged during engine operation. The transmitting/receiving optics pair 22, 26 is secured to the port 24 and the outer casing in a manner enabling them to function as the plug they replace. The transmitting/receiving optics pair 22, 26 are configured for operative association with the port 24 in the outer casing of the gas turbine so that the transmitting optic and the receiving optic are optically coupled by reflecting the beam 30 off a portion 32 of the inner casing 16 substantially opposite the port 24. As used in the '081 application, “substantially opposite” means positioned so that light reflects off the portion 32 of the inner casing in a near-specular manner between the transmitting/receiving optics pair. In this manner, a line of sight between the transmitting optic 22 and the receiving optic 26 can be achieved in the combustion zone of the gas turbine engine with minimal intrusion. In an alternative embodiment of the '081 application illustrated in FIG. 3, the transmitting optic 22 may direct the beam 34 illustrated in phantom lines off the inner casing to a receiving optic 26 associated with a distinct port. In such an embodiment the portion 36 of the inner casing upon which the beam is reflected would be between the transmitting/receiving optics 22, 26.

Returning to the '081 application embodiment illustrated in FIG. 4, the beam 30 is reflected off the portion 32 of the inner casing 16 in a near-specular manner so that it nearly retraces its path to the receiving optic 26 located in close proximity to the transmitting optic. The portion 32 of the inner casing may be polished or coated in some manner to increase the reflectivity of the portion 32 of the inner casing. The size of the portion may vary in accordance with tolerances, but a section as small as 5 mm in diameter may be sufficient to significantly improve the optical transmission. In addition or as an alternative to polishing a portion of the inner casing, a coating of a highly reflective material may be applied to the portion 32 of the inner casing. Alternatively or in addition, the portion 32 of the inner casing may be treated to resist collection of soot deposits. All manner of treating the portion 32 of the inner casing to improve reflectivity and minimize soot deposition are with the scope of the invention.

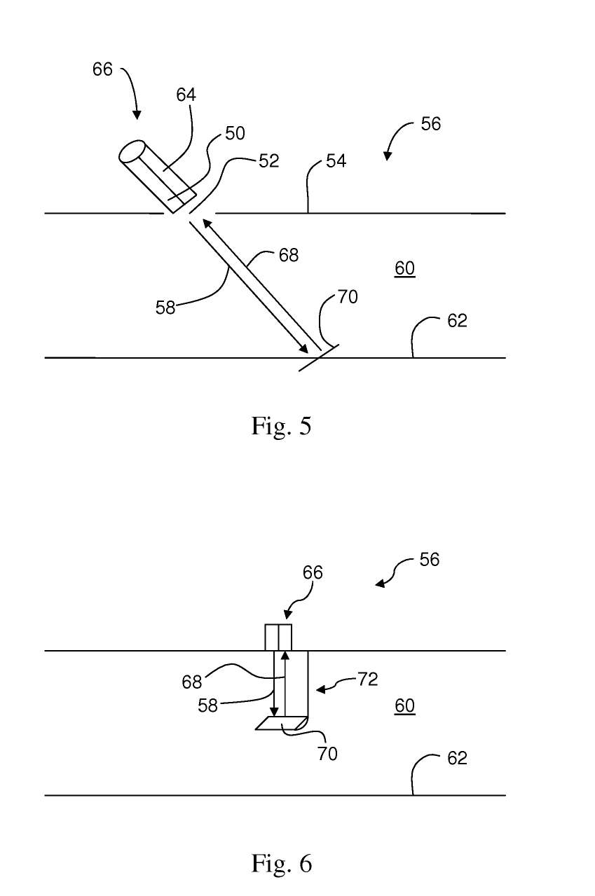

These embodiments which are fully disclosed in the '081 application can, in certain instances, be difficult to implement. In particular, it may be difficult to position a transmitting optic so that the spectroscopy probe beam may be transmitted to a portion of the inner casing which is substantially opposite the port. For example, FIG. 5 schematically illustrates an embodiment where a transmitting optic 50 is coupled to a port 52 in the outer casing 54 of a gas turbine engine 56. The transmitting optic 50 is positioned to transmit a beam 58 through a combustion zone 60. The transmitted beam 58 is transmitted along a line which, in this embodiment, is not substantially normal to the inner casing 62 of the gas turbine engine 56. The transmitting optic 50 is associated with a receiving optic 64 in a unified single-ended probe 66 which is coupled to the port 52. Thus, the reflected beam 68 which is received by the receiving optic 64 will travel along substantially the same line as the transmitted beam 58. Accordingly, it is desirable to provide a normal surface 70 off of which the transmitted beam 58 may reflect.

As used herein, a normal surface 70 is defined as any surface which has a portion which is substantially normal to a center line between the path of the transmitted beam 58 and the path of the reflected beam 68. Many embodiments will include a single-ended probe where the path of the transmitted beam 58 and the path of the reflected beam 68 are substantially parallel since the transmitting optic 50 and receiving optic 64 are positioned adjacent to each other in single-ended embodiments. Those skilled in the art will recognize, however, that any separation between the transmitting optic 50 and the receiving optic 64 will result in a measurable angle between the transmission and the receiving optical paths. Thus, the normal surface 70 is specifically defined as being substantially normal to the center line between the transmission and reflected optical paths. Accordingly, the normal surface 70 will function to reflect the transmitted beam 58 substantially toward the receiving optic 64.

The normal surface 70 may have a shape which is substantially planar, spherical, or a complex shape provided that some portion of the normal surface 70 is situated to reflect the transmitted beam 58 back toward the receiving optic 64. The normal surface 70 may be associated with a structure which is substantially stationary with respect to the engine housing. Or, the normal surface 70 may be included on a moving structure. For example, the normal surface 70 may be a portion of the turbine axle, or a series of turbine fan blades. Thus, the normal surface 70 may be on moving structures which are intermittently situated to reflect the transmitted beam 58 back toward the receiving optic 64. In addition, the normal surface 70 may be a surface on a structure such as a turbine axle which structure has another primary functional purpose. Alternatively, the normal surface 70 may be included on a separate structure which is attached to another engine component.

The normal surface 70 may, in select embodiments, be fabricated into the inner casing 62 of the gas turbine engine 56, provided the normal surface 70 is offset at a select angle from adjacent portions of the inner casing 62. Thus, the normal surface 70 may be a raised structure on the inner casing 62, or an indentation fabricated into the inner casing 62. The normal surface 70 may be made by attaching a separate structure to the inner casing 62, or machining or otherwise removing a portion of the inner casing 62.

For example, as shown in the schematic illustration of FIG. 6, the normal surface 70 may be on a structure separate from the inner casing 62 of the gas turbine engine 56. As is shown in FIG. 6, the normal surface is on a cantilevered reflecting surface 72 which extends into the combustion zone 60. As is also shown in FIG. 6, the normal surface 70, if associated with a separate structure, may be positioned so that the transmitted beam 58 is projected along a line which has any selected angle with respect to the inner casing 62 of the gas turbine engine 56. Thus, the transmitted beam 58 may be projected along a line which is normal to the inner casing of the gas turbine engine.

In certain embodiments, it may be desirable to polish the reflecting surface such as the normal surface 70, or coat the normal surface 70 with a highly reflective substance. In these embodiments, the selected surface treatment enhances specular reflection. Specular reflection as defined herein is reflection from a smooth surface, such as a minor, which tends to maintain the integrity of the incident beam wave front.

Alternatively, the reflecting surface such as the normal surface 70 may be treated to enhance or provide a predominately Lambertian reflection. Lambertian reflection occurs when the incident beam is scattered such that the apparent brightness of the beam on the normal surface 70 is approximately the same to an observer regardless of the observer's angle of view. Thus, Lambertian reflection is a diffuse reflection. It will be readily apparent to those skilled in the art that Lambertian reflection from a normal surface 70 will tend to decrease the intensity of the reflected beam 68. However, Lambertian reflection will tend to overcome minor misalignment between the transmission and receiving optics, 50 and 64 respectively. Lambertian reflection may be enhanced by bead blasting, sanding, painting, application of a thermal barrier coating (TBC) or otherwise treating the normal surface 70 to provide for a diffuse reflection.

The reflecting surface 70, including the normal surface could comprise a machined feature that acts as a corner cube to enhance reflectivity. In another embodiment, a Littrow mode diffraction grading may be etched on the reflective surface to provide high reflectivity when the beam is perpendicular to the surface. In another embodiment, ceramic spheres could be added to a thermal barrier coating (TBC) similar to 3M Scotch-Brite and applied to the reflective surface. Such ceramic spheres act as a corner cube to enhance reflectivity and provide a return beam directly along the path of the transmitted beam. In another embodiment corner cubes may be implemented as a micro-machined array in order to make the received signal more tolerant of misalignment, beam steering, vibration and the like.

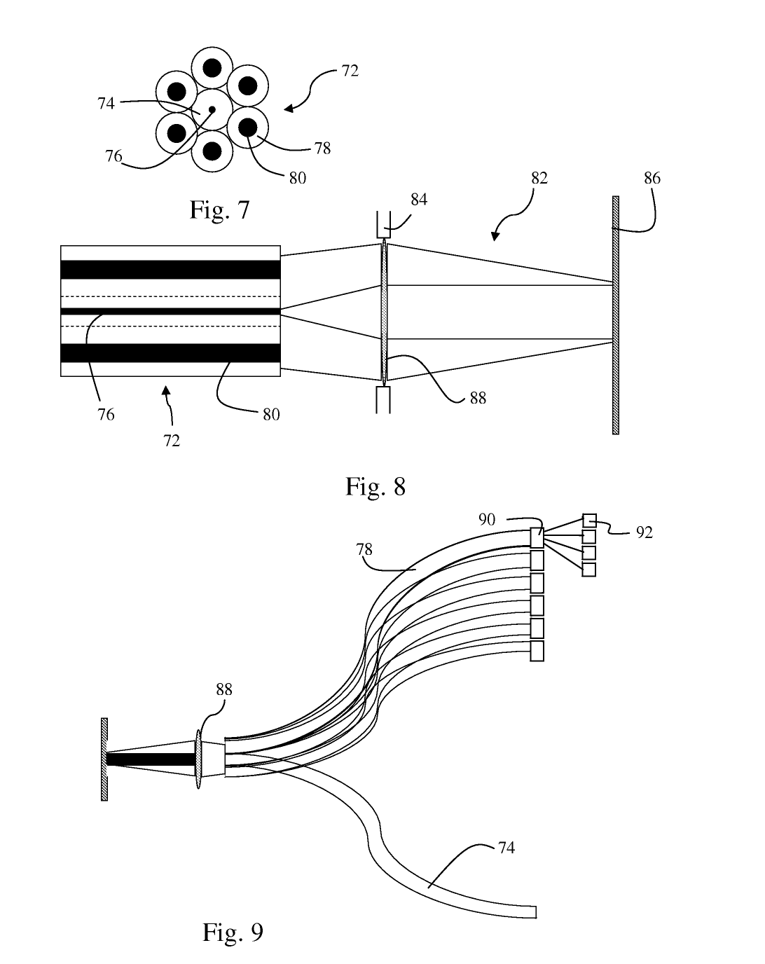

As described above, the single-ended probe 66 includes both transmission optics 50 and receiving optics 64. FIG. 7 is a schematic diagram of a first embodiment of an alignment free single-ended optical probe 72. The first embodiment of the alignment free single-ended optical probe 72 comprises a fiber assembly comprising a single mode transmit fiber 74 having a single mode transmit core 76 surrounded by a multimode receive core means, which in this embodiment comprises a plurality of multimode receive fibers 78 each having a multimode receive core 80. One known supplier of such a bundle is Fiberguide Industries, Inc. of Stirling, N.J.

FIG. 8 is a schematic representation of the first embodiment of the alignment free single-ended optical probe 72 deployed in operative association with a measurement volume 82 such as in or in proximity to a combustion zone of a gas turbine engine between an outer casing 84 and an inner casing 86. Alternatively, the inner casing 86 could be any normal reflective surface of the type discussed above. A laser beam is coupled to the single mode core 76 which emits a beam which is collimated by the lens 88 and reflected off the reflection surface 86 and thereafter received by the collimating lens 88 and further received in the plurality of multimode fiber cores 80. Sufficient emitted light is coupled by the collimating optic to each of the multimode fibers to provide for measuring desired combustion properties. The fiber bundle arrangement eliminates the need for realignment of the single mode transmit fiber relative to the multimode receive fibers during use.

Currently two structures and methods are contemplated for measuring the detection beam captured by the multimode fiber. Referring to FIG. 9, a single large area detector (not shown) might be used to detect light from all multimode catch fibers. However, the intrinsic capacitance of such a large area detector may cause its response to be too slow for suitable response times. As a second possibility, separate detectors may be required for each multimode fiber and the detected signals can be summed electronically downstream of the detectors. As depicted in FIG. 9, the single mode fiber 74 emits a wavelength multiplexed beam. In such an embodiment a separate demultiplexer 90 must be optically coupled to each multimode fiber where after distinct wavelengths are directed to distinct detectors 92.

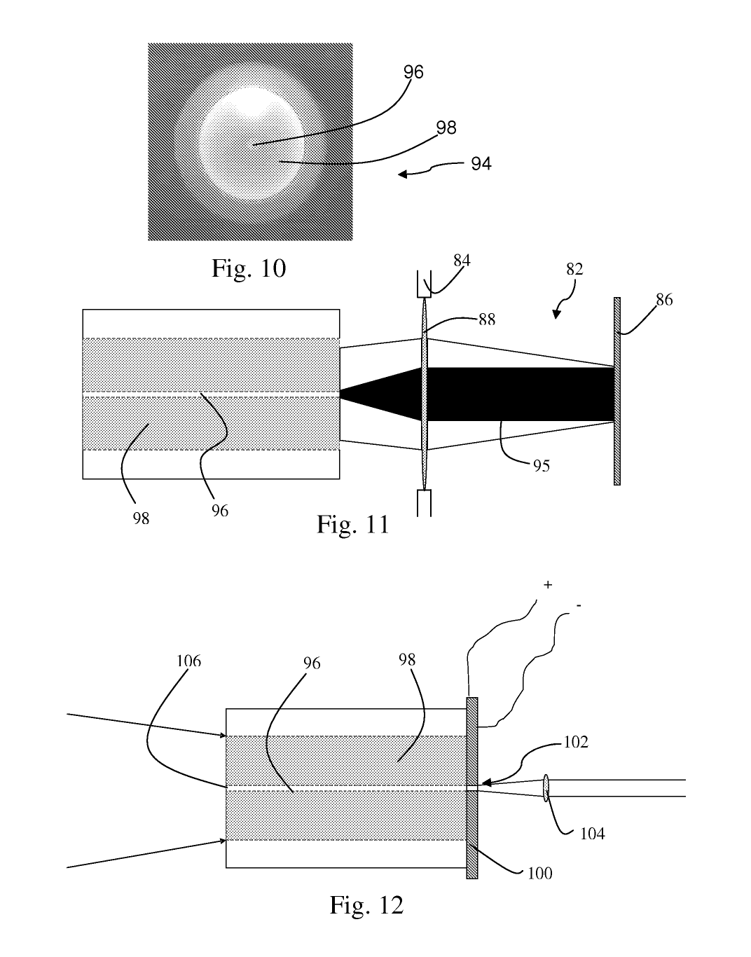

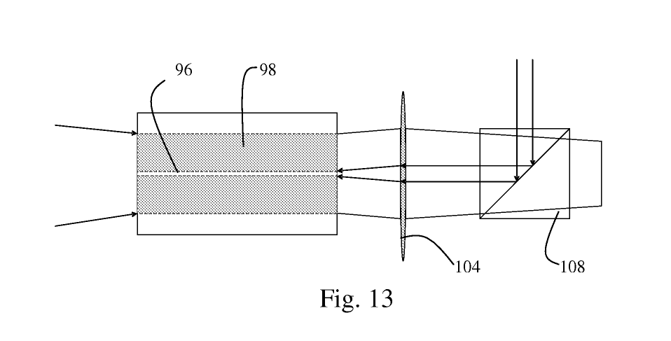

A second embodiment of an alignment free single-ended optical probe 72 is depicted in FIG. 10. Such an embodiment uses a dual core fiber 94 comprising a single mode transmit core 96 encased by a concentric integrally formed multimode receiving core 98, which comprises another embodiment of a multimode receive core means. Such a dual core fiber is available from Fibercore Ltd., Hampshire, UK. In use, a transmitted beam 95 from a laser is coupled to the single mode transmit core 96, directed to a collimating lens 88, bounced off a reflecting surface 86 in a measurement volume 82 and the reflected light is then collimated by the lens 88 and received in the receiving multimode core 98, as depicted in FIG. 11. Use of this type of fiber presents some difficulty in coupling the pitch light to the single mode transmit core 96 and decoupling the light and directing it to a detector after it is collected in the outer multimode core 98 since the transmitted and received light contains the same wavelengths. At least two possibilities exist for accomplishing this objective. First, referring to FIG. 12, the dual core fiber 94 can be abutted directly to a detector 100 having a small hole 102 in the center. The returning multimode light strikes the detector giving rise to the desired detection signal. The transmit beam is focused into the single mode core by lens 104 before being emitted at 106. An alternative embodiment would utilize a polarization beam splitter 108 as depicted in FIG. 13.

With the use of a multiplexed transmit beam, the received light beam would need to be demultiplexed prior to optical coupling with a detector. Referring to FIG. 12, in such an embodiment the detector 100 could be replaced with a demultiplexer and then the demultiplexed wavelengths could each be associated with discrete wavelength detector.

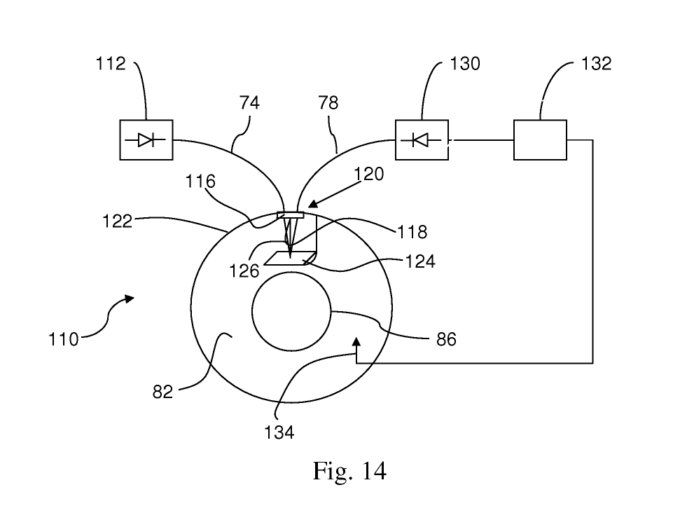

FIG. 14 illustrates schematically one embodiment in the form of a system or sensing apparatus 110 for sensing, monitoring and control of a combustion process using the first embodiment of an alignment free single-ended optical probe 72. The apparatus 110 comprises a tunable diode laser 112 that is optically coupled to a single mode transmit 74 fiber. The optical fiber 74 is further optically coupled to a transmitting/receiving optic 116 which may include a collimating lens or other optics suitable for producing a collimated transmitted beam 118. As used herein, “coupled” or “optically coupled” or “in optical communication with” is defined as a functional relationship between counterparts where light can pass from a first component to a second component either through or not through intermediate components or free space. The transmitting/receiving optic 116, is optically coupled to a port 120 in the cylindrical outer casing 122, whereby the beam 126 is transmitted off a normal reflecting surface 124 to be received by the transmitting/receiving optic 116. In the embodiment illustrated in FIG. 14, the normal surface 124 is associated with a structure which is separate from the inner casing 86 of the gas turbine engine. Alternatively, the normal surface 124 may be associated with the inner casing 86 as described above. The normal surface 124 may be treated as described above to enhance either specular or Lambertian reflectivity.

In the first embodiment, transmitting/receiving optic 116 is optically coupled to a plurality of surrounding optical multimode fibers 78 (only one shown in FIG. 14). Each optical fiber 78 is optically coupled to a detector 130, which typically is a photodetector sensitive to the frequency of laser light generated by laser 112. The detector 130 generates an electrical signal based upon the nature and quantity of light transmitted to the detector 130. The electrical signal from the detectors 130 is digitized and analyzed in a computer or data processing system 132. The computer 132 is programmed to determine a combustion property, such as temperature or a concentration of at least one combustion species, based upon the output of the detector. The computer may further be programmed to control engine input parameters such as air and fuel provided to the combustion zone as a function of the concentration of the combustion species, as illustrated by the arrow 134. Alternatively, or in combination, the computer 132 may be programmed to determine an engine malfunction based upon the concentration of a combustion species and produce a warning signal.

The invention contemplates the use of fiber optic coupling to the electronic and optical components on both the transmitting and receiving sides of the sensing apparatus 110 to allow delicate temperature sensitive apparatus such as the tunable diode laser 112, the detector 130 and the data processing system or computer 132 to be located in a suitable operating environment away from the gas turbine engine. Thus, only the relatively robust transmitting/receiving optics 116 need to be situated near the hostile environment of the measurement volume 82.

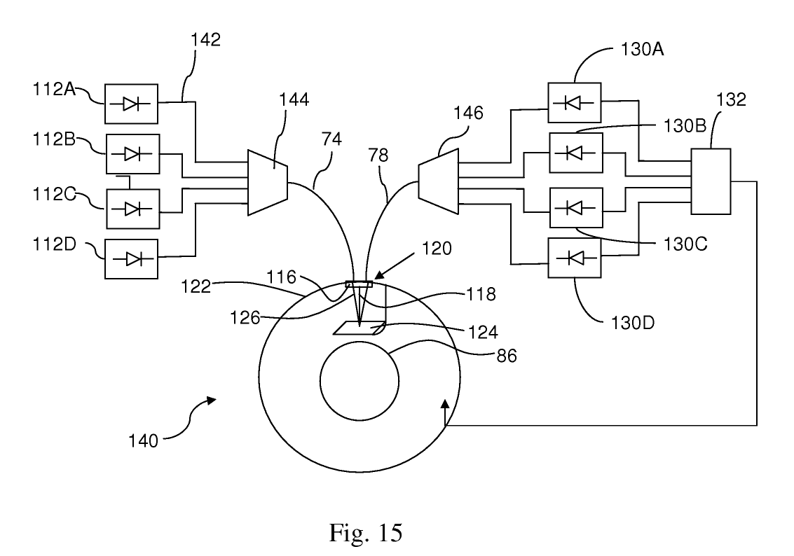

FIG. 15 schematically illustrates a multiplexed sensing apparatus 140. Like reference numbers refer to the same elements as described with respect to FIG. 14. In this embodiment a plurality of tunable diode lasers 112A-112D are optically coupled to an optical fiber 142 (which may be a single mode optical fiber) and routed to a multiplexer 144. Within the multiplexer 144 laser light from some or all of the diode lasers 112A-112D is multiplexed to form a multiplexed beam having multiple select frequencies. The multiplexed beam is optically coupled to the single mode optical transmit fiber 74 and transmitted to the transmitting/receiving optic 116. The transmitting/receiving optic 116 is optically coupled to a port 120 in an outer cylindrical casing 122 of a gas turbine engine, as described with respect to FIG. 14. As with FIG. 14, the transmitted beam 118, which in this case is a multiplexed beam, is reflected off a normal surface 124 for receipt by the transmitting/receiving optic 116. The transmitting/receiving optic 116 optically communicates with a demultiplexer 146 by means of multimode receive optical fiber 78. Again, the first embodiment contemplates a plurality of multimode receive fibers 78 surrounding transmit fiber 74, though only one is shown for clarity. The demultiplexer 146 demultiplexes the multiplexed reflected beam 126 to discrete wavelengths and each wavelength is optically communicated to a corresponding detector 130A-130D, which in turn is coupled to the data processor or computer 132, which may be programmed as discussed above with respect to the computer 132 of FIG. 14.

The embodiment illustrated in FIG. 15 may include any number of tunable diode lasers 112A-112D generating a variety of wavelengths, though only four are illustrated for the sake of simplicity. A like number of photodiode detectors 130 are provided.

The multiplexer 144 and demultiplexer 146 may be components designed for use it the telecommunications industry. Suitable multiplexers/demultiplexers are described in greater detail in WO '496, referenced above. Other aspects of the method and apparatus for the monitoring and control of combustion described in WO '496 may be included with the apparatus described in FIGS. 14 and 15 as necessary or desired. For example, using multiple sets of transmitting/receiving optics pairs and optical switches and/or routers to provide a beam of multiplexed light to each pair and for providing the beam to the detectors may be useful, particularly for a tomographic representation of combustion properties wherein the combustion zone.

Various embodiments of the disclosure could also include permutations of the various elements recited in the claims as if each dependent claim was multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A method of measuring a combustion property in a measurement volume within a casing defined in part by a casing wall comprising:
providing a port in the chamber wall;
providing a fiber assembly, the fiber assembly comprising a single mode transmit core surrounded by multimode receive core means;
optically coupling the fiber assembly to the port to provide optical communication between the fiber assembly and the measurement volume;
transmitting a detection beam capable of detecting a select combustion property from single mode fiber;
reflecting the detection beam off a reflection surface within the chamber, the reflection surface being configured to reflect and optically couple at least a portion of the deflection beam to the multimode receive core means; and
measuring the detection beam optically coupled to the multimode receive core means.

2. The method of claim 1 wherein the multimode receive core means comprises a plurality of multimode fibers abuttingly surrounding a singe mode fiber comprising the singe mode core.

3. The method of claim 1 wherein the multimode receive core means comprises an integral multimode core encasing the single mode core.

4. The method of claim 2 wherein the measuring step comprises optically coupling a single detector to all of the plurality of multimode fibers.

5. The method of claim 2 wherein the measuring step comprises optically coupling a distinct detector to each multimode fiber.

6. The method of claim 1 wherein the transmitting step comprises transmitting a wavelength multiplexed beam of light from the single mode fiber, the method further comprising demultiplexing the at least a portion of the wavelength multiplexed beam of light and the measurement step further comprising measuring each of the multiplexed wavelengths of light.

7. An apparatus for measuring the combustion property of a measurement volume within a casing defined in part by a casing wall, the apparatus comprising:
a fiber assembly comprising a single mode transmit core surrounded by multimode receive core means;
means optically coupling the fiber assembly to a port in the chamber wall;
a reflection surface within the chamber configured to reflect at least a portion of the detection beam to the multimode receiver core means; and
a detector optically coupled to the multimode receive core means for measuring at least a portion of the detection beam.

8. The apparatus of claim 7 wherein the multimode receive core means comprises a plurality of multimode fibers each having a multimode fiber core abuttingly surrounding a single mode fiber comprising the single mode core.

9. The apparatus of claim 7 wherein the multimode receive core means comprises an integral multimode core encasing the single mode core.

10. The apparatus of claim 8 wherein a single detector is optically coupled to all the multimode fibers.

11. The apparatus of claim 8 further comprising a distinct detector optically coupled to each multimode fiber.

12. The apparatus of claim 7 further comprising a demultiplexer optically coupled to the multimode receive core means; and
a plurality of detectors optically coupled to the demultiplexer for measuring each demultiplexed wavelength.
